(19) United States
(12) Patent Application Publication
(10) Pub. No.: US 2018/0234768 A1
(43) Pub. Date: Aug. 16, 2018

(54) Speaker System

(71) Applicant: Lingbin Kong, Brookhaven, GA (US)

(72) Inventor: Lingbin Kong, Brookhaven, GA (US)

(21) Appl. No.: 15/893,029

(22) Filed: Feb. 9, 2018

Related U.S. Application Data
(60) Provisional application No. 62/457,583, filed on Feb. 10, 2017.

(51) Int. Cl. H04R 5/02; H04S 1/00; H04R 3/12; H04R 1/44; H04R 1/02

(52) U.S. Cl. CPC H04R 5/02; H04S 1/007; H04R 3/12; H04R 2420/09; H04R 1/025; H04R 1/023; H04R 2420/07; H04R 1/44

(57) ABSTRACT

A speaker system includes two speaker units, each including: a waterproof shell, a front vertical side of which defining a sound opening passing therethrough; a magnetic base at the bottom of the shell configured to hold together the speaker units when the magnetic bases of the two speaker units are placed together, the front vertical side of each will point in a common direction; a rechargeable battery within the shell; a speaker adjacent the sound opening; and an electronic circuit that communicates with the wireless device and demodulates the wireless signal to drive the speaker. A flexible protective covering has a shape that is complimentary in shape to the two speakers when the two speakers are held together at the magnetic bases. The flexible protective covering holds the two speakers together therein.

### CROSS-REFERENCE TO RELATED APPLICATION(S)

This application claims the benefit of U.S. Provisional Patent Application Ser. No. 62/457,583, filed Feb. 10, 2017, the entirety of which is hereby incorporated herein by reference.

### BACKGROUND OF THE INVENTION

### 1. Field of the Invention

The present invention relates to speaker systems and, more specifically, to a portable speaker system.

### 2. Description of the Related Art

Portable speaker systems can be used to project sound received from a wireless device, such as a cellular telephone, using a wireless personal area network system, such as Bluetooth®. Most stereo portable speaker systems are either unitary devices in which two speakers are held together in a single plastic casing or they include two independent speakers. Unitary devices do not provide a strong stereo effect due to the close proximity of the speakers, whereas independent speaker systems do not lend themselves to use during many physical activities, such as hiking and bicycle riding.

Therefore, there is a need for a speaker system that includes two independent speakers that can be held together as a single unit.

### SUMMARY OF THE INVENTION

The disadvantages of the prior art are overcome by the present invention which, in one aspect, is a speaker system for generating sound corresponding to a wireless signal transmitted from a wireless device. The speaker system includes two speaker units. Each speaker unit includes: a waterproof shell including at least a bottom and a front vertical side, the front vertical side defining a sound opening passing therethrough; a magnetic base at the bottom of the shell configured to hold together the speaker units when the magnetic bases of the two speaker units are placed together, the two speaker units will be held together with the front vertical side of each speaker unit pointing in a common direction; a rechargeable battery disposed within the shell; a speaker disposed adjacent the sound opening so as to be configured to project sound therethrough; and an electronic circuit powered by the battery and configured to communicate with the wireless device, the electronic circuit further configured to demodulate a portion of the wireless signal and to drive the speaker with an electrical signal corresponding thereto. A flexible protective covering has a shape that is complimentary in shape to the two speakers when the two speakers are held together at the magnetic bases. The flexible protective covering is configured to hold the two speakers together therein.

In another aspect, the invention is a portable speaker system for generating sound corresponding to a wireless signal transmitted from a wireless device, which includes two speaker units. Each speaker includes: a waterproof shell including at least a bottom and a front vertical side, the front vertical side defining a sound opening passing therethrough and a hemispherical top portion; a waterproof screen disposed adjacent to the sound opening so as to prevent water from entering the shell through the sound opening; a magnetic base at the bottom of the shell configured to hold together the speaker units when the magnetic bases of the two speaker units are placed together, the two speaker units will be held together with the front vertical side of each speaker unit pointing in a common direction; a rechargeable battery disposed within the shell; a speaker disposed adjacent the sound opening so as to be configured to project sound therethrough; and an electronic circuit powered by the battery and including a short range wireless communication standard chipset that is configured to communicate with the wireless device, the electronic circuit further configured to demodulate a portion of the wireless signal and to drive the speaker with an electrical signal corresponding thereto. A silicone rubber protective covering defines an interior void that is complimentary in shape to the two speakers when the two speakers are held together at the magnetic bases and configured to hold the two speakers together therein. The flexible protective covering includes a tubular member having a rounded first end and an opposite rounded second end connected to the rounded first end by four planar orthogonal sides, including a front side that defines an opening passing therethrough that exposes the sound opening of each speaker unit. An attachment ring is affixed to the silicone rubber protective covering and is disposed at a selected end, the attachment ring configured attach to flexible protective covering to an attachment device. The two speaker units are configured so as to communicate with each other so that a first one of the two speaker units will play a left channel of a stereo signal and so that a second one of the two speaker units, different from the first one, will play a right channel of the stereo signal.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a perspective view of one embodiment of a speaker unit.

FIG. 1B is a cross-sectional view of the embodiment shown in FIG. 1A, taken along line 1B-1B.

FIG. 1C is a left side elevational view of the embodiment shown in FIG. 1A.

FIG. 1D is a front side elevational view of the embodiment shown in FIG. 1A.

FIG. 1E is a right side elevational view of the embodiment shown in FIG. 1A.

FIG. 1F is a back side elevational view of the embodiment shown in FIG. 1A.

FIG. 2 is a schematic drawing of a speaker unit that is attached to a ferrous surface.

FIG. 3A is a schematic diagram showing a first way in which two speaker units interact with a portable electronic device.

FIG. 3B is a schematic diagram showing a second way in which two speaker units interact with a portable electronic device.

FIG. 3C is a schematic diagram showing a single speaker unit interacting with a portable electronic device.

FIG. 3D is a schematic diagram showing a two speaker units, each interacting independently with a portable electronic device.

FIG. 4 is a perspective view of a speaker system that includes two speaker units joined together at their bases.

FIG. 5 is a drawing of a protective covering.

FIGS. 6 is a perspective view of a speaker system in a protective covering.

FIG. 7 is a schematic diagram of a portable speaker system affixed to a bag.

FIG. 8 is a schematic diagram of a portable speaker system disposed in a water bottle holder of a bicycle.

FIGS. 9A-9B are two views of a speaker system being hung in alternate ways.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “subwoofer” refers to either an active powered speaker or a passive radiator.

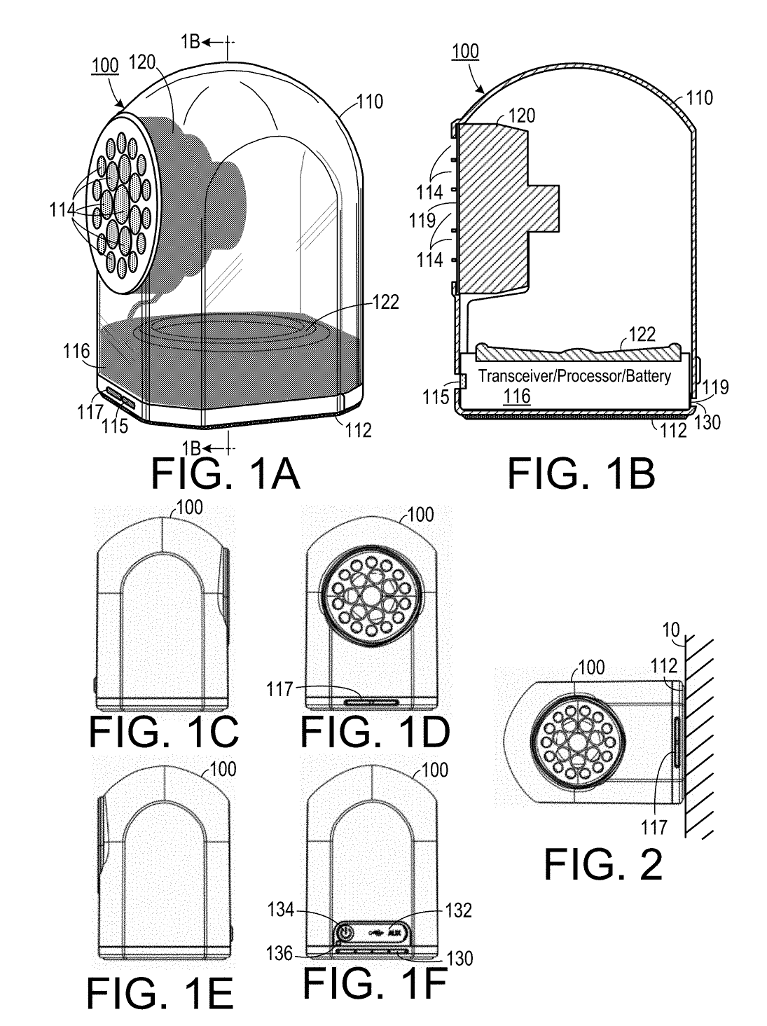

As shown in FIGS. 1A-1F, one embodiment of a speaker unit 100 includes a shell 110 with a magnetic bottom surface 112. The shell 110 (which can also be referred to as a “casing”) can be clear for aesthetic purposes and, in other embodiments, it can be opaque or translucent. The shell 110 can include one of many materials, including plastics such as: high density polyethylene, polypropylene, nylon, polycarbonate, urethane, polyurethane, acrylic, acrylonitrile butadiene styrene, polyvinyl chloride, etc., depending on the specific application and desired molding method. The shell 110 defines a sound opening area 114 against which is placed a speaker 120. A “sub-woofer” type unit 122 is disposed underneath speaker 120 and an electronics unit 116 is disposed near the bottom of the speaker unit 100. The electronics unit 116 includes a rechargeable battery, a wireless communications transceiver circuit and an amplifier. The subwoofer 122 can be an active subwoofer that is coupled to the electronic circuit, or it can be a passive device (also referred to as a “passive radiator”) that resonates certain frequencies of sound produced by the speaker 120. Slots 130 are provided to allow sound from the subwoofer 122 to pass therethrough.

The speaker unit 100 can have a built-in microphone 115 which is located underneath the subwoofer 122 behind the slots on the front 117. With the microphone, the speaker unit 100 can work as a speakerphone. The speaker unit 100 can also support voice-command and/or speech-recognition functions based on handset or cloud service via its wireless connectivity. A waterproof screen/shuttle 119 can be added behind the slots on the front side and back side to make the speaker unit 100 waterproof

In one embodiment, the wireless communications circuit (such as a personal area network circuit conforming to the Bluetooth standard, a standard for wirelessly exchanging data over short distances using short-wavelength UHF radio waves in the ISM band from 2.4 to 2.485 GHz from fixed and mobile devices) is used to communicate music from a wireless device to the speaker unit 100. Other methods of communicating music to the speaker unit 100 can be employed. For example, music can be input via a USB port (which may be protected by a flexible cover 132, which can keep out water and dust) or other commonly known type of auxiliary port. Music can also be input using other wireless methods, such as Wi-Fi. The battery unit 116 can also be recharged in several ways (depending upon the specific design), including: through the USB port, through an auxiliary power port, or through wireless power transfer. A multi-function button 134 and a speaker status indicator light (such as an LED) 136 can also be provided. The multi-function button can be used for power on and power off of the speaker unit 100. It can also be used for pairing two speaker units 100 and answering, terminating or rejecting telephone calls, etc.

As shown in FIG. 2, the speaker unit 100 can be placed against a ferrous surface 10 (e.g., a refrigerator door, a computer case or a car door) and held there by the magnetic bottom surface 112. It can also be placed upright in a desktop configuration.

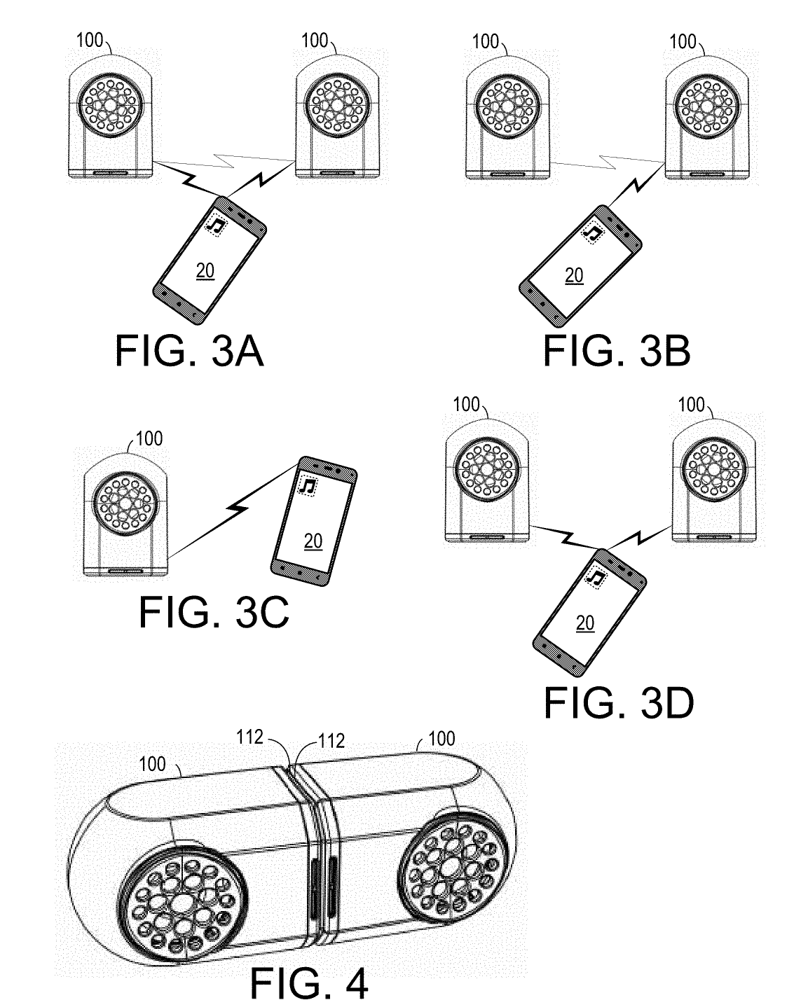

As shown in FIG. 3A, in one embodiment a portable electronic wireless device 20, such as a smart phone, a tablet and the like, can communicate with two speaker units 100 simultaneously and the two speaker units 100 can communicate with each other so as to differentiate between playing the right channel and the left channel of a stereo signal. This mode is supported by devices employing a short range wireless communication standard chipset, such as a chipset employing the Bluetooth 5.0 standard. In another embodiment, as shown in FIG. 3B, the wireless device 20 communicates directly with only a single one of the speaker units 100, which then communicates with the other speaker unit 100. As shown in FIG. 3C, the system can also be used in a single speaker unit 100 mode. As shown in FIG. 3D, the system can also be operated in “party mode,” in which the wireless device 20 communicates directly and independently with two speaker units 100 so that they play the same music simultaneously. In this mode, the left channel and the right channel are combined into a monaural signal.

As shown in FIG. 4, two speaker units 100 can be held against each other by their magnetic bottom surfaces 112 to form a speaker system. If the speaker units 100 have flat side surfaces, then the speaker system can be placed securely on a flat surface, such as a desk. The two battery-powered wireless speakers 100, each having a magnetic base, can be joined together at the magnetic bases 112. When the two speakers 100 work together, wireless connectivity is setup in between the two units, and they will play left-channel and right-channel respectively but simultaneously, as a stereo system. The stereo system can work when the two speakers 100 are attached together for portability, or placed apart for larger sound field. The speakers can work apart wirelessly so as to expand the sound field without problems associated with wire connectivity. Also, the speakers 100 fit in multiple environments, from small desktop to living room or bigger.

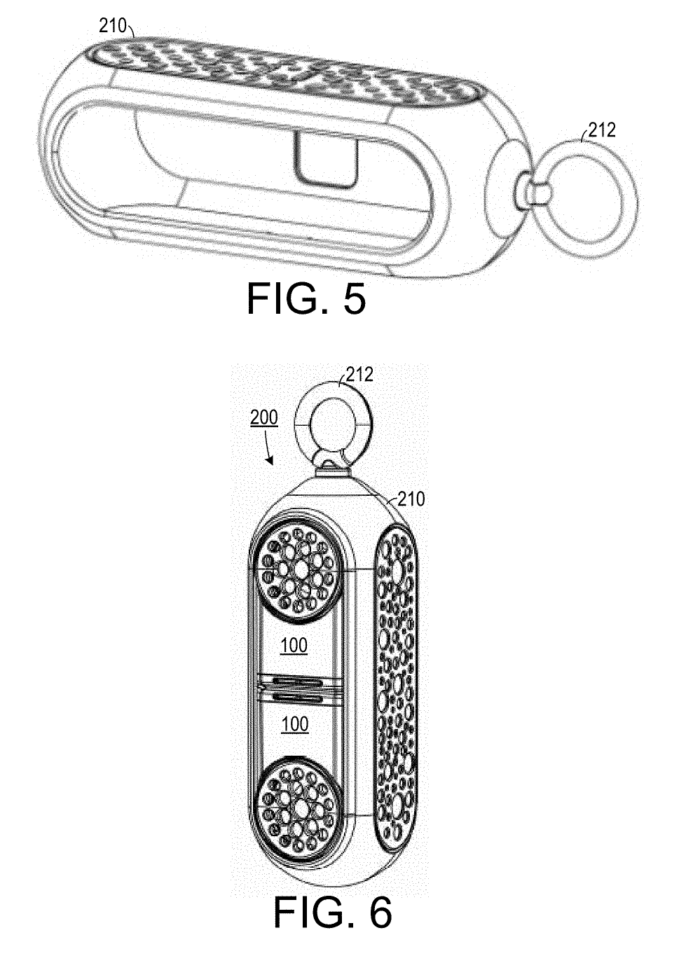

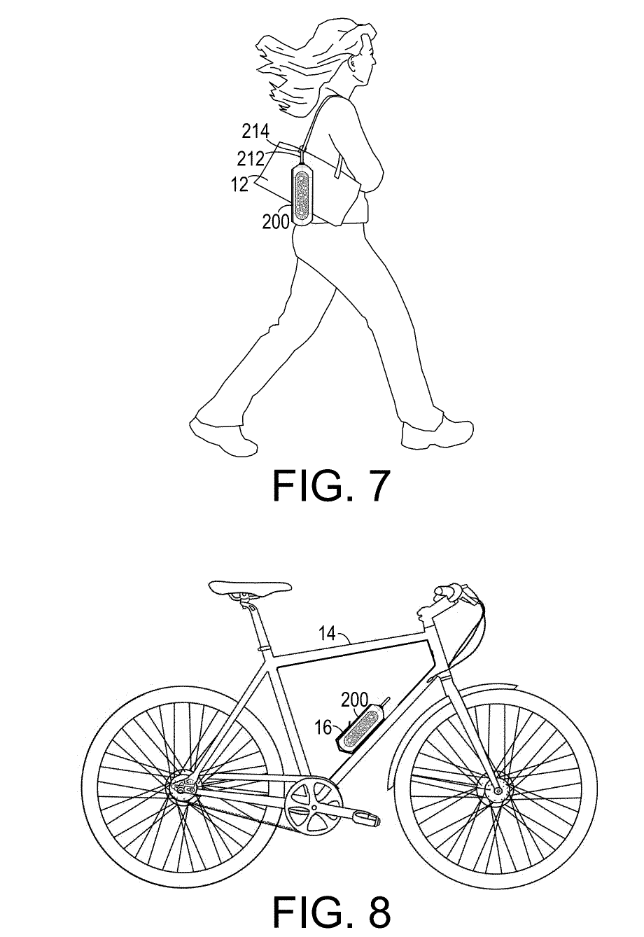

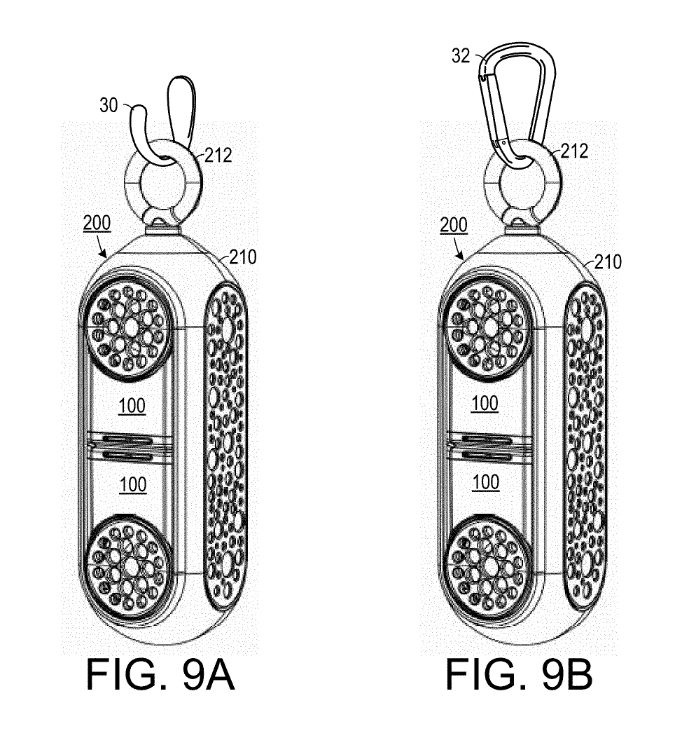

As shown in FIGS. 5 and 6, a protective covering 210 can be used to hold the speakers 100 so as form a portable speaker system 200. The protective covering 210 can be made of one of many different flexible and elastic materials, including silicone rubber, thermoplastic polyurethane, thermoplastic elastomer, etc. It can provide impact resistance and make the speaker system 200 waterproof. An attachment ring 212 can be integrally affixed to the protective covering 210. The attachment ring 212 can be used to attach the portable speaker system 200 to other objects by itself (such as on a hook, nail, etc.) or by using a clip, a carabiner, or the like. For example, as shown in FIG. 7, the portable speaker system 200 can be attached to an item like a purse 12 or a backpack with a carabiner 214 for easy carrying. Also, as shown in FIG. 8, the speaker units 100 and the protective covering 210 can have a form factor that is sized and shaped so that the portable speaker system 200 can fit into the water bottle cage (or holder) 16 of a bicycle 14 and be held securely therein. Because of its portability, ease of carrying, impact resistance and water resistance the portable speaker system 200 is well suited for use in active environments, such as camping, hiking, sports, and the like. As shown in FIG. 9A, the portable speaker system 200 can hang from a hook 30. As shown in FIG. 9B, it can also be attached to something using a carabiner 32 or other attachment device.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A speaker system for generating sound corresponding to a wireless signal transmitted from a wireless device, comprising:
(a) two speaker units, each speaker including:
(i) a waterproof shell including at least a bottom and a front vertical side, the front vertical side defining a sound opening passing therethrough;
(ii) a magnetic base at the bottom of the shell, configured to hold together the speaker units when the magnetic bases of the two speaker units are placed together;
(iii) a rechargeable battery disposed within the shell;
(iv) a speaker disposed adjacent the sound opening so as to be configured to project sound therethrough; and
(v) an electronic circuit powered by the battery and configured to communicate with the wireless device, the electronic circuit further configured to demodulate a portion of the wireless signal and to drive the speaker with an electrical signal corresponding thereto; and
(b) a flexible protective covering having a shape that is complimentary in shape to the two speakers when the two speakers are held together at the magnetic bases and configured to hold the two speakers together therein.

2. The speaker system of claim 1, wherein the electronic circuit comprises a short range wireless communication standard chipset.

3. The speaker system of claim 1, wherein the two speaker units are configured so as to communicate with each other so that a first one of the two speaker units will play a left channel of a stereo signal and so that a second one of the two speaker units, different from the first one, will play a right channel of the stereo signal.

4. The speaker system of claim 1, further comprising a waterproof screen disposed adjacent to the sound opening so as to prevent water from entering the shell through the sound opening.

5. The speaker system of claim 1, wherein each speaker unit further comprises a subwoofer.

6. The speaker system of claim 1, wherein each speaker unit further comprises a microphone in data communication with the electronic circuit.

7. The speaker system of claim 1, wherein the shell comprises a material selected from a list of materials consisting of: high density polyethylene, polypropylene, nylon, polycarbonate, urethane, polyurethane, acrylic, acrylonitrile butadiene styrene, polyvinyl chloride and combinations thereof.

8. The speaker system of claim 1, wherein the shell of each speaker unit includes at least one of a universal serial bus port and an auxiliary port in electrical communication with the electronic circuit.

9. The speaker system of claim 1, wherein the flexible protective covering comprises a material selected from a list of materials consisting of: silicone rubber, thermoplastic polyurethane, thermoplastic elastomer, and combinations thereof.

10. The speaker system of claim 1, wherein the flexible protective covering further comprises an attachment ring affixed thereto and disposed at a selected end that is configured attach to flexible protective covering to an attachment device.

11. The speaker system of claim 1, wherein the two speakers and the flexible protective covering, when the two speakers are attached at the magnetic bases and are placed in the flexible protective covering, have a form factor that permits the speakers and the flexible protective covering to be held securely by a bicycle water bottle cage.

12. The speaker system of claim 1, wherein the flexible protective covering comprises a tubular member having a rounded first end and an opposite rounded second end connected to the rounded first end by four planar orthogonal sides, including a front side that defines an opening passing therethrough that exposes the sound opening of each speaker unit.

13. A portable speaker system for generating sound corresponding to a wireless signal transmitted from a wireless device, comprising:
(a) two speaker units, each speaker including:
(i) a waterproof shell including at least a bottom and a front vertical side, the front vertical side defining a sound opening passing therethrough and a hemispherical top portion;
(ii) a waterproof screen disposed adjacent to the sound opening so as to prevent water from entering the shell through the sound opening;
(iii) a magnetic base at the bottom of the shell, configured to hold together the speaker units when the magnetic bases of the two speaker units are placed together;
(iv) a rechargeable battery disposed within the shell;
(v) a speaker disposed adjacent the sound opening so as to be configured to project sound therethrough; and
(vi) an electronic circuit powered by the battery and including a short range wireless communication standard chipset that is configured to communicate with the wireless device, the electronic circuit further configured to demodulate a portion of the wireless signal and to drive the speaker with an electrical signal corresponding thereto;
(b) a silicone rubber protective covering defining an interior void that is complimentary in shape to the two speakers when the two speakers are held together at the magnetic bases and configured to hold the two speakers together therein, the flexible protective covering including a tubular member having a rounded first end and an opposite rounded second end connected to the rounded first end by four planar orthogonal sides, including a front side that defines an opening passing therethrough that exposes the sound opening of each speaker unit; and
(c) an attachment ring affixed to the silicone rubber protective covering and disposed at a selected end, the attachment ring configured attach to flexible protective covering to an attachment device,
wherein the two speaker units are configured so as to communicate with each other so that a first one of the two speaker units will play a left channel of a stereo signal and so that a second one of the two speaker units, different from the first one, will play a right channel of the stereo signal.

14. The portable speaker system of claim 13, wherein each speaker unit further comprises a subwoofer.

15. The portable speaker system of claim 13, wherein each speaker unit further comprises a microphone in communication with the electronic circuit.

16. The portable speaker system of claim 13, wherein the shell comprises a material selected from a list of materials consisting of: high density polyethylene, polypropylene, nylon, polycarbonate, urethane, polyurethane, acrylic, acrylonitrile butadiene styrene, polyvinyl chloride and combinations thereof.

17. The portable speaker system of claim 13, wherein the shell of each speaker unit includes at least one of a universal serial bus port and an auxiliary port in electrical communication with the electronic circuit.

18. The portable speaker system of claim 13, wherein the two speakers and the flexible protective covering, when the two speakers are attached at the magnetic bases and are placed in the flexible protective covering, have a form factor that permits the speakers and the flexible protective covering to be held securely by a bicycle water bottle cage.
